(19) United States
(12) Patent Application Publication
(10) Pub. No.: US 2026/0194073 A1
(43) Pub. Date: Jul. 9, 2026

(54) CEILING FAN ASSEMBLY WITH HANGER BRACKET ASSEMBLY

(71) Applicant: Hunter Fan Company, Memphis, TN (US)

(72) Inventors: Charles William Botkin, Cordova, TN (US); Douglas Troy Mason, Horn Lake, MS (US); Rickey Thomas Jones, Memphis, TN (US)

(21) Appl. No.: 19/384,089

(22) Filed: Nov. 10, 2025

Related U.S. Application Data
(60) Provisional application No. 63/741,554, filed on Jan. 3, 2025.

(51) Int. Cl. F04D 29/64; F04D 19/00; F04D 25/08; F04D 3/00

(52) U.S. Cl. CPC F04D 29/646; F04D 19/002; F04D 25/088; F04D 3/00

(57) ABSTRACT

A ceiling fan assembly or similar air-moving device can include a rotor for rotating one or more blades to drive a volume of air about a space. The ceiling fan assembly comprising a hanger bracket assembly having a hanger bracket, a ball seat, and a hanger ball seated within the ball seat. A clamp can be provided for applying compressive force to the hanger ball to restrict pivotal or rotational movement.

### CROSS-REFERENCE TO RELATED APPLICATION

This application claims priority to U.S. Provisional Patent Application No. 63/741,554, filed January 3, 2025, currently pending, of which is hereby incorporated herein by reference in its entirety.

### TECHNICAL FIELD

This description is directed to a ceiling fan assembly, and more specifically, to a ceiling fan assembly having a hanger bracket assembly for mounting a ceiling fan to a structure, and further to a hanger bracket assembly that fixes the position of the ceiling fan relative to the structure.

### BACKGROUND

Ceiling fans are machines traditionally suspended from a structure for moving a volume of air about an area. The ceiling fan includes multiple parts, such as assemblies, components, and/or elements, that must be coupled to each other as part of the installation of the ceiling fan. The installation of the ceiling fan has traditionally been accomplished with fasteners, brackets, and the like, to secure the ceiling fan to the structure. For example, a bracket receiving the downrod is fastened to a bracket that is secured to the ceiling.

### BRIEF DESCRIPTION

In one aspect, the disclosure relates to a hanger bracket assembly for mounting a ceiling fan to a structure, the hanger bracket assembly comprising a hanger bracket having a structure mount and a ball seat depending from the structure mount, a downrod terminating in a hanger ball, which is seated in the ball seat for pivotal or rotational movement, and a clamp pivotally coupled to the hanger bracket and pivotal between an un-clamped position and a clamped position, where in the clamped position, the clamp applies a force to hanger ball to lock the hanger ball in place and prevent the pivotal or rotational movement.

In another aspect, the disclosure relates to a ceiling fan assembly for mounting to a structure, the ceiling fan assembly comprising a hanger bracket having a structure mount and a ball seat, a ceiling fan having a rotor, a plurality of blades operably coupled to the rotor, a downrod having a first end and a second end, with the second end coupled to the ceiling fan, a hanger ball couples to the first end of the downrod and is received within the ball seat, a clamp applying a compressive force to the hanger ball to press the hanger ball against the ball seat, and a hinged coupling the clamp and the hanger bracket, wherein the clamp is pivoted about the hinged coupling between a clamped position, where the clamp applies the compressive force to the hanger ball, and an un-clamped position.

In yet another aspect, the disclosure relates to a method of fixing a relative position of a hanger ball in a hanger bracket in a ceiling fan mounting assembly, the method comprising: forming a hinged coupling between a clamp and the hanger bracket; pivoting the clamp about the hinged coupling in a clamped position where the clamp applies a compressive force to the hanger ball to bias the hanger ball against the hanger bracket; and fixing the clamp in the clamped position.

### BRIEF DESCRIPTION OF THE DRAWINGS

In the drawings:

FIG. 1 is an exploded view of a ceiling fan assembly having elements such as a motor assembly, mounting assembly, light assembly, and blades, which can be mounted by a hanger bracket assembly.

FIG. 2 is a exploded view of the hanger bracket assembly of FIG. 1 and illustrating its components of a hanger bracket, a ball seat, a hanger ball, and a clamp.

FIG. 3 is a partially exploded view illustrating the hanger ball seated in the ball seat and the clamp.

FIG. 4 is a partially exploded view illustrating the clamp overlying the hanger ball in an un-clamped position.

FIG. 5 illustrates the clamp overlying the hanger ball in a clamped position.

FIG. 6 is a cross-sectional view of a portion of the clamp overlying the hanger ball in the clamped position as seen from sectional line VI-VI of FIG. 5, further illustrating a position of the clamp relative to the hanger ball.

FIG. 7 is a flowchart illustrating a method of fixing a relative position of a hanger ball to a hanger bracket in accordance with aspects of the disclosure.

FIGS. 8 and 9 illustrate an alternative latch from the clamp to hold the clamp in the clamped position.

### DETAILED DESCRIPTION

In one aspect, the disclosure relates to a ceiling fan mounting assembly, which can be used, for example, in residential, agricultural, industrial, and commercial applications. More specifically, this disclosure relates to a hanger bracket assembly for mounting a ceiling fan. Some hanger bracket assemblies include a ball seat or socket receiving a hanger ball to pivotally mount the ceiling fan to a surface. Such pivotal or rotational movement can allow the ceiling fan to be mounted on a wide variety of surfaces, including sloped ceilings, or at an angle relative to the surface. However, after mounting, the pivotal and rotational movement can lead to contact between the rotating blades and the surface if the fan moves relative to the surface mount in response to an external force that causes unwanted motion of the fan. For ceiling fans mounted outdoors or in buildings open to the outdoors, such an external force can include blowing from a strong breeze against the mounted ceiling fan that has the ceiling fan pivoting, rotating, or rocking in place which could cause the fan to swing and impact the mounting surface or other surrounding surfaces.

In another aspect, the disclosure relates to a hanger bracket assembly that uses a clamp to fix the angular/pivoting orientation of the ceiling fan relative to the surface mount to prevent the angular/pivoting movement in response to the external force. The clamp can have an un-clamped position and a clamped position. In the un-clamped position, the clamp can allow the hanger ball to pivotally move or rotate the fan to a desired angular/pivoting orientation. After securing the fan to the surface, the clamp can move to a clamped position where the clamp applies a force to the hanger ball and locks the hanger ball in place, preventing angular/pivoting movement. The clamp is pivotally coupled to the hanger bracket and the clamp pivots to move between the un-clamped and clamped positions such that the mounting and locking of the ceiling fan can be done by a single individual. The clamp has an opening that receives the hanger ball when the clamp is in the clamped position. This opening allows the clamp to supply the desired clamping force while advantageously residing below an uppermost portion of the hanger ball and maintaining a low profile that does not increase the size of the hanger bracket. Additionally, a latch can secure the clamp to the hanger bracket in the clamped position by passing a fastener through the clamp and the hanger bracket.

The hanger bracket assembly, as discussed herein, utilizes the clamp to both hold together a hanger ball in a hanger bracket and, in the clamped position, reduces movement of the mounted ceiling fan by restricting the angular/pivotal movement of the hanger ball relative to the hanger bracket. Such applications can be indoors, outdoors, or both. While this description is primarily directed toward a residential ceiling fan, it is also applicable to any environment utilizing fans or for cooling areas utilizing air movement.

As used herein, the term “set” or a “set” of elements can be any number of elements, including only one. All directional references (e.g., radial, axial, proximal, distal, upper, lower, upward, downward, left, right, lateral, front, back, top, bottom, above, below, vertical, horizontal, clockwise, counterclockwise, forward, aft, etc.) are only used for identification purposes to aid the reader’s understanding of the present disclosure, and do not create limitations, particularly as to the position, orientation, or use of aspects of the disclosure described herein. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

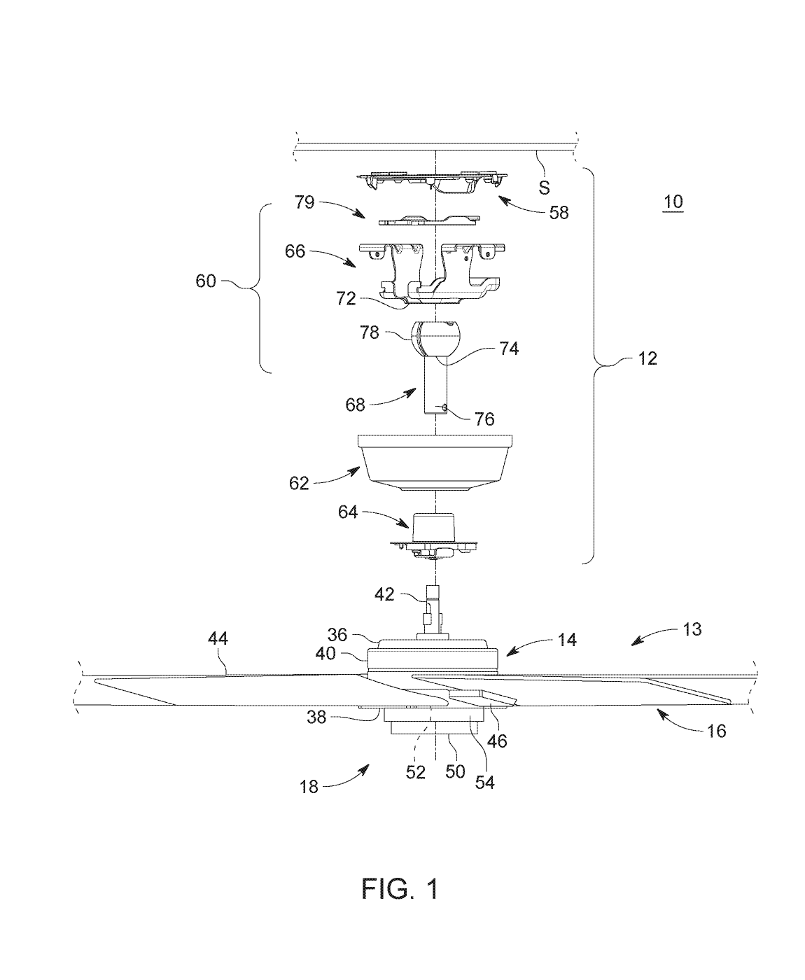

Referring to FIG. 1, a ceiling fan assembly 10 is suspended from a structure S. The structure S can be a ceiling. However, it should be understood that the structure S is schematically shown and is by way of example only. The structure S can include any suitable building, home, business, or other environment wherein moving air with a ceiling fan is suitable or desirable. The structure can also be a wall, instead of a ceiling. The structure can also be a beam on a wall or ceiling. The structure can further be a dedicated structure, such as a pole or the like, to support the fan.

The ceiling fan assembly 10 includes a mounting assembly 12 and a ceiling fan 13 having a motor assembly 14, a blade set 16, and, optionally, a light assembly 18.

The motor assembly 14 can include a motor 36, which can be enclosed, fully or partially, by an optional motor housing (not shown). The motor 36 comprises a rotor 38, stator 40, and a motor shaft 42. As illustrated the motor 36 is an external rotor motor, where at least a portion of the rotor 38 circumscribes the stator 40, and the stator 40 is affixed to the motor shaft 42, which is non-rotating. Since the motor shaft 42 is non-rotating, the rotor 38 is rotationally coupled to the non-rotating motor shaft 42, such as by the use of one or more bearing assemblies (not shown). While not shown in the drawings, it is contemplated that the motor 36 could be an internal rotor motor, wherein the rotor is secured to the motor shaft, which rotates with the rotor. Since the internal rotor has a rotating motor shaft, the stator can be connected to the rotating motor shaft by one or more bearing assemblies.

The blade set 16 can have one or more blades 44, which can be operably coupled to the rotor 38, either directly or indirectly by using a blade iron 46. In the case of an internal rotor motor, the blades 44 can be connected by a blade iron 46 or similar structure connected to either the rotor 38 or the rotating motor shaft 42.

The light assembly 18 can include a light housing 50 that carries an illumination source 52, such as an LED light or LED array. Other illumination sources, like traditional light bulbs may also be used instead of or in combination with the LED light source. A globe 54 can be affixed to the light housing 50 and covers the illumination source 52 for aesthetic purposes. The globe 54 can be made of any suitable material, such as glass or plastic, and have any suitable degree of transparency. The light housing 50 can also enclose mechanical or digital switches for turning on/off/dimming of the illumination source 52 and/or controlling the on/off/speed of the motor 36. Thus, the light housing 50 can also be referred to as a switch housing, especially when an illumination source 52 is not included. In a variation where the illumination source 52 is not included, a cover (not shown), including an opaque cover, can be used instead of the globe 54.

The mounting assembly 12 can include a mounting bracket 58, a hanger bracket assembly 60, a canopy 62, and, optionally, a motor adapter 64, where the hanger bracket assembly 60 includes at least a hanger bracket 66 and a downrod 68. The mounting bracket 58 is typically the primary coupling with the structure S. The hanger bracket 66 couples the downrod 68 to the mounting bracket 58. The canopy 62 can be provided to visually hide the mounting bracket 58 and the hanger bracket 66. In one variation, the mounting bracket 58 can be integrated with the hanger bracket 66 and/or the hanger bracket 66 can be directly mounted to the structure, eliminating the need for the mounting bracket.

The hanger bracket 66 can include a ball seat 72 and the downrod 68 has a first end 74 and a second end 76 where, at the first end 74, the downrod 68 can terminate in a hanger ball 78 that is received within the ball seat 72. The first end 74 can be integrally formed with or mechanically coupled to the hanger ball 78. The second end 76 of the downrod 68 can couple to the ceiling fan 13 by connecting the downrod 68 to the motor assembly 14 either directly at the second end 76 or indirectly using the motor adapter 64 to secure the second end 76 to the motor assembly 14. As such, the downrod 68 couples the ceiling fan 13 to the hanger bracket 66. The hanger ball 78 received within the ball seat 72 permits pivotal or rotational movement of the downrod 68 and the affixed ceiling fan 13 relative to the hanger bracket 66. In this way, the downrod 68 can pivot, typically by grasping and pivoting the downrod 68 or allowing downward (i.e., gravitationally aligned) suspension of the ceiling fan 13, to a desired angular position and can accommodate instances where the structure S is an inclined or angled mounting surface.

A clamp 79 cooperates with the hanger bracket 66 to fix the angular orientation of the downrod 68 relative to the hanger bracket 66 by applying a compressive clamping force onto the hanger ball 78 to compressively retain the hanger ball 78 between the clamp 79 and the ball seat 72. The clamp 79 can be treated as part of the hanger bracket assembly 60 because of physical proximity but is not necessarily functionally part of the hanger bracket assembly.

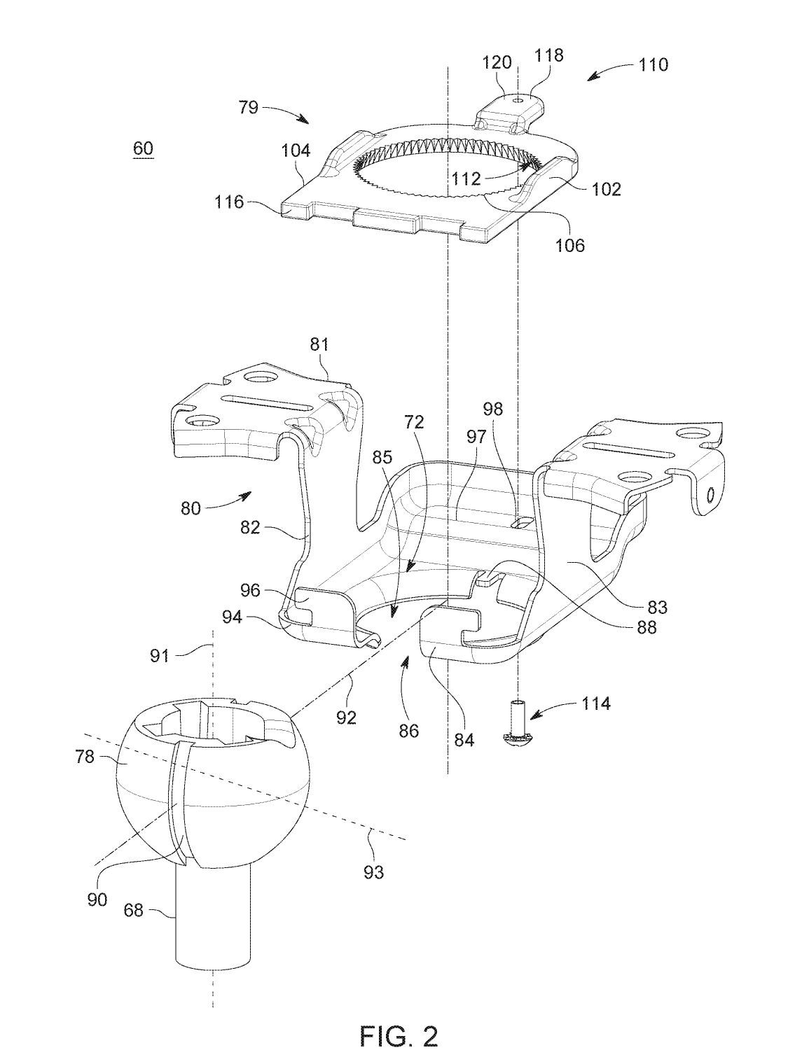

Referring to FIG. 2, the relationship between and details of the hanger bracket assembly 60 are shown and described in greater detail. The hanger bracket 66 includes a structure mount 80, which is illustrated in the form of mounting arms 81 that can have a plurality of through holes for receiving fasteners, such as screws or bolts, to secure the structure mount 80 to mounting bracket 58. In some applications, the connection between the mounting arms 81 and the mounting bracket 58 are elastomeric grommets, which provide vibration damping. Alternatively, traditional fasteners (screws, bolts, etc.) can mechanically fasten the mounting arms 81 to the mounting bracket 58. In cases where a mounting bracket 58 is not used, the fasteners can be used to secure mounting arms 81 directly to the structure S. Even when the elastomeric grommets and/or the mounting bracket 58 is used, fasteners can pass through both the mounting arms 81 and the mounting bracket to secure the hanger bracket 66 and mounting bracket 58 to the structure S.

A pair of struts 82, 83 suspend the ball seat 72 from the mounting arms 81. The ball seat 72 includes an open collar 84, defining a ball opening 85, and a downrod slot 86, which is where the open collar 84 ‘opens’ to allow the downrod 68 to pass through. The ball opening 85 and the downrod slot 86 are sized to receive the downrod 68, while the ball opening 85 is also sized to allow the hanger ball 78 to sit cradled in the ball seat 72. In this way, the downrod 68 can be together with the hanger ball 78 before the downrod 68 passes through the downrod slot 86 or the ball opening 85. The ball opening 85 is shaped to conform with the shape of at least a portion of the hanger ball 78. A suitable shaped ball opening 85 includes anything that is polygonal or arcuate, such as the illustrated circle. When the hanger ball 78 is located in the ball opening 85, the hanger ball 78 can, at least initially, be rotated/pivoted about a longitudinal axis 91 and a first axis 92 and a second axis 93.

A rotation-limiting structure can be provided that impacts at least two rotational degrees of freedom by permitting limited pivotal movement of the hanger ball 78 relative to the ball seat 72, which prevent relative rotational movement of the hanger ball 78 in the ball seat 72. As illustrated by way of non-limiting example, the ball opening 85 can be shaped having a rotation-limiter tab 88, and a complementary groove or longitudinal slot 90 formed in the hanger ball 78, which receives the rotation-limiter tab 88. Two longitudinal slots 90 can be formed on diametrically opposed sides of the hanger ball 78 to ease assembly when receiving the rotation-limiter tab 88. When the rotation-limiter tab 88 is received in the longitudinal slot 90, rotation of the hanger ball 78 about the longitudinal axes 91, 92 is prevented while pivoting rotation about the axis 93 is permitted.

While the rotation-limiting structure is illustrated as limiting two rotational degrees of freedom, it can just as easily be configured to limit one or three rotational degrees of freedom. Also, for purposes of operation of the clamp 79, the rotation-limiting structure, while useful, is not required.

A complemental clamping structure is provided with the hanger bracket 66 to enable the functional operation of the clamp 79. The complementary clamping structure includes at least one slot 94, formed with the ball seat 72, that is configured to engage with a portion of the clamp 79. As illustrated, there are two slots 94, which happen to be located on opposite sides of the downrod slot 86. The slots 94 are formed by L-shaped hook or arm 96 extending from the open collar 84 on either side of the downrod slot 86. The location of the slots 94 are not limited to the illustrated location, nor are hooks or arms 96 need to form the slots. For example, the open collar 84 can be formed taller and the slots formed in the wall. Another alternative is to locate the slots 94 on the other side of the ball seat 72, the same side as the tab 88, as slots in the wall.

The complementary clamping structure further includes a support ledge 97 extending from the open collar 84. The support ledge 97 can support a portion of the clamp 79. The support ledge 97 includes at least one through hole 98 for receiving a fastener 114, such as a screw or a bolt, to secure the clamp 79 in a closed or locking position. The location of the hole 98 and the fastener 114 can be changed to other locations on the support ledge 97 and the structure mount 80 for that matter.

The clamp 79 includes a plate body 104, defining a plate opening 106 and having a latch 110, which can be used to secure the clamp to the hanger bracket 66. As illustrated, the plate body 104 is in the form a flat plate facing the ball seat 72 where the plate opening 106 can be provided centrally within the plate body 104. An interior facing surface of the plate body 104 defining the plate opening 106 can form a catch face 112 that will confront a portion of the hanger ball 78 when the clamp 79 is provided to the hanger ball 78. The catch face 112 can have a serrated edge or be a serrated surface 113 about the plate opening 106. The serrated edge or serrated surface 113 can be formed of individual features (e.g., projections and depressions) of any desired number or geometry provided they function resisting or restricting the capability of movement of the hanger ball 78 relative to the catch face 112. It is further contemplated in another alternative example that the catch face 112 can have a smooth edge or smooth surface without any serration.

A deflection ridge 102, having the form of a ramp or inner angled surface, can be provided along a periphery of the plate body 104 on either side of the plate opening 106 to strengthen or improve rigidity in the plate body 104 against bending when acted upon by an applied force.

Tabs 116 are provided on the plate body 104 and correspond with the slots 86, 94 of the ball seat 72. The tabs 116 received within the slots 94 in an overlapping relationship function to form a hinge or pivot point. Receiving the tabs 116 within the slot 86 functions more as an alignment feature, not as a hinge or pivot axis. The latch 110 is a latching finger 120 that extends from the plate body 104 and has a through hole 118 that overlies the through hole 98 in the support ledge 97. The latching finger 120 is shaped or bent to conform with the shape of a portion of the support ledge 97.

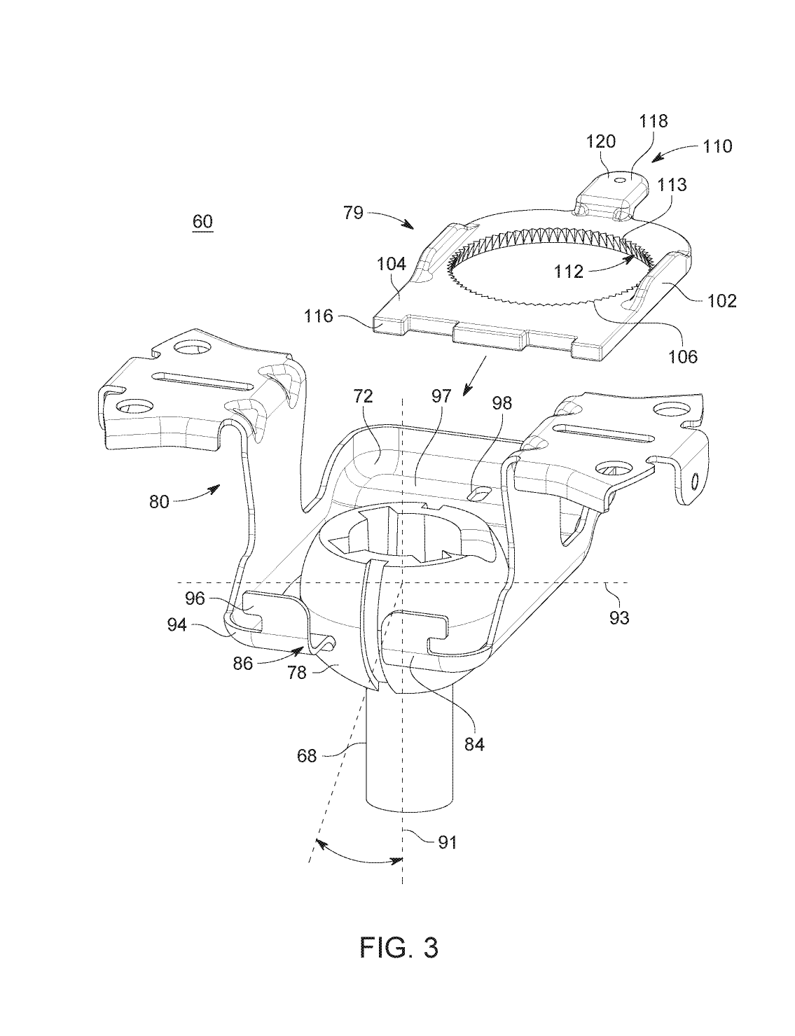

We will now turn to the mounting of the downrod 68 to the hanger bracket 66 and the fixing of the downrod 68 in a desired rotational orientation using the clamp 79. We begin with reference to FIG. 3, where, initially, the hanger ball 78 is seated in the ball seat 72 by passing the downrod 68 through the downrod slot 86 and then lowering the hanger ball 78 onto the ball seat 72, where, as illustrated, the longitudinal slot 90 receives the rotation-limiter tab 88 and restricts rotation of the hanger ball 78 about the longitudinal axis 91.

While the illustrated examples herein show the alignment of the longitudinal slot 90 and the rotation-limiter tab 88 happening at the same time as the movement of seating the hanger ball 78 in the ball seat 72, such coordination is not required. For example, the hanger ball 78 can be lowered into the ball seat 72 and rotated about the longitudinal axis 91 until the rotation-limiter tab 88 connects into the longitudinal slot 90, which can provide tactile feedback, e.g., a sound, a feel, or both, that the hanger ball 78 is properly seated in the ball seat 72 such that further twisting or circumferential rotation of the hanger ball 78 about the longitudinal axis 91 is restricted.

Once the hanger ball 78 is seated, the clamp 79 can then be used to fix the angular position of the downrod 68. Prior to using the clamp 79, the hanger ball 78 can be pivoted, typically by grasping the downrod 68 and pivoting the downrod 68 to the desired angular position. In some examples, the angular orientation can be vertically aligned or perpendicular to the structure S. In other examples, the angular orientation can be offset from vertical, such as along inclined or angled mounting surfaces where gravitational alignment is offset from being perpendicular to the structure S.

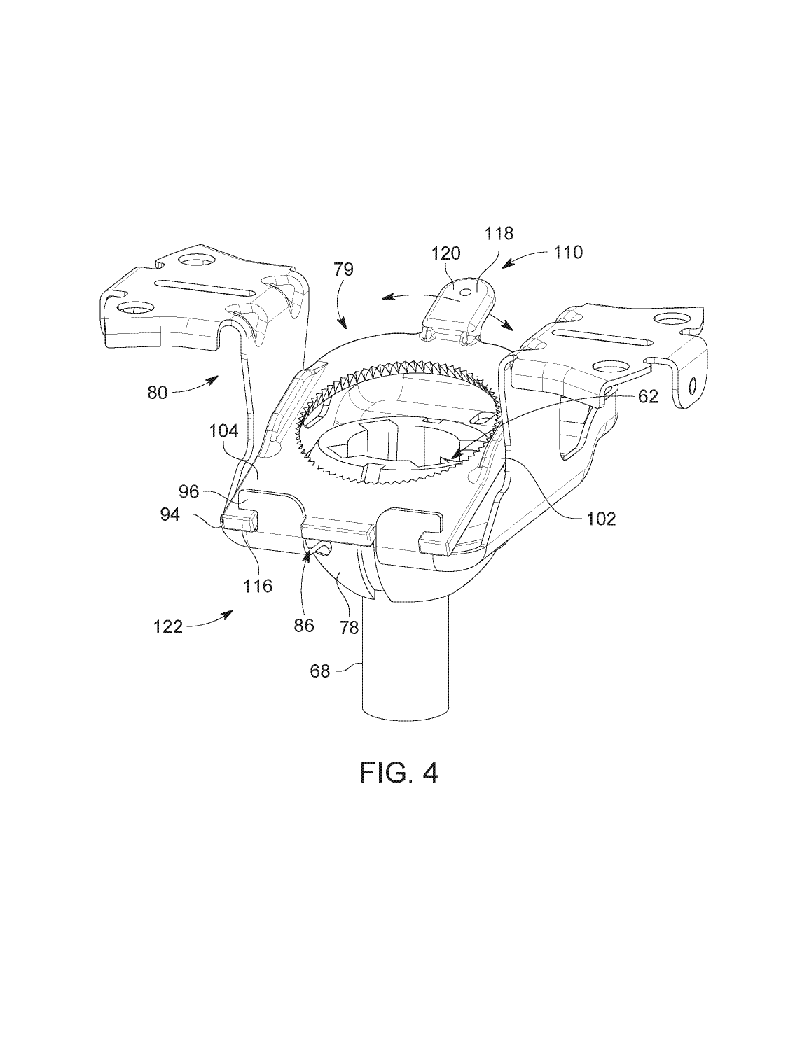

Referring to FIG. 4, once in the downrod 68 is in the desired angular position, the clamp 79 is moved into position to fix the downrod 68 in the desired angular orientation. Initially, the clamp 79 is moved into position relative to the hanger ball 78 by passing the clamp 79 between the mounting arms 81 and above the hanger ball 78. The clamp 79 is oriented, during or after being positioned above the hanger ball 78, such that the tabs 116 are lowered into the slots 94 of the ball seat 72 as seen in FIG. 4, which can be referred to as an un-clamped position

When the tabs 116 are slidably engaged into the slots 94, they collectively form a hinged coupling 122 between the clamp 79 and the hanger bracket 66. When the hinged coupling 122 is formed, the plate opening 106 overlies the hanger ball 78 along the pivot path of the plate opening 106. In this way, the pivoting about the hinged coupling 122 will relatively move the hanger ball 78 into the plate opening 106 and bring the catch face 112 into contact with the hanger ball 78.

While the hinged coupling 122 is illustrated as tabs 116 on the clamp 79 engaging in slots 94 of the ball seat 72, in an alternative and non-limiting example, it is contemplated that the clamp 79 includes the slot and the ball seat 72 includes the tab received in the slot to form the hinged coupling 122.

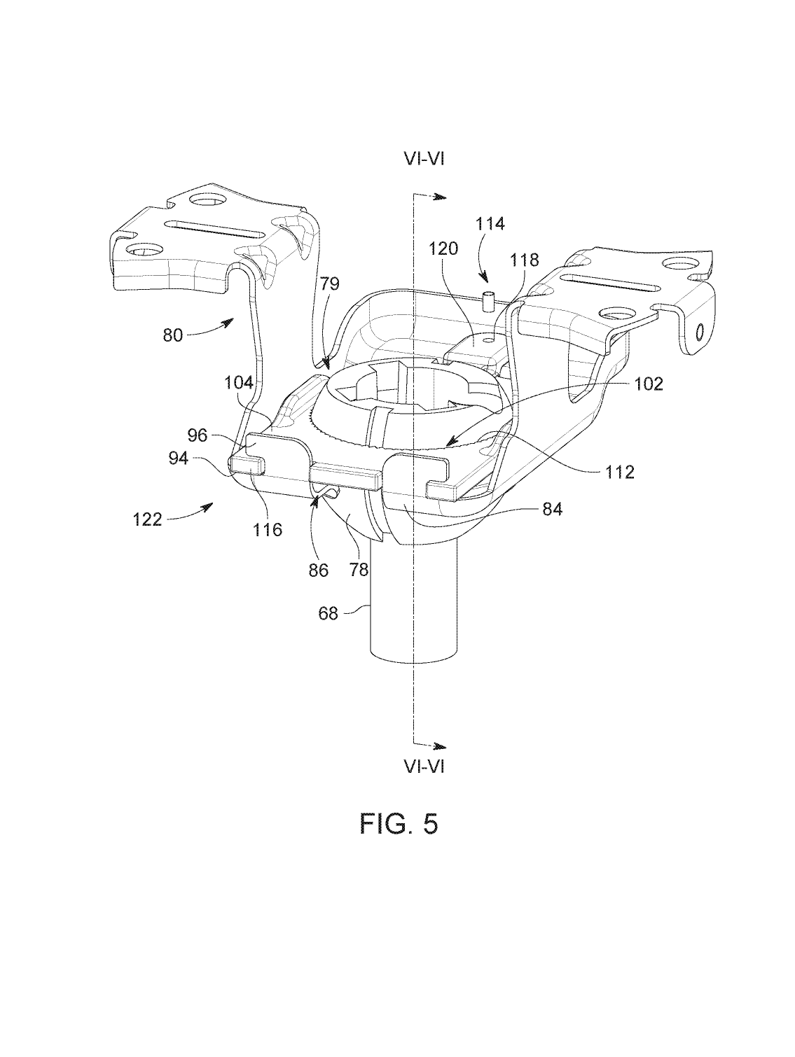

Referring to FIG. 5, the clamp 79 can be moved about the hinged coupling 122 from the un-clamped position of FIG. 4 to the clamped position of FIG. 5. As the clamp 79 is moved to the clamped position, the plate opening 106 receives a portion of the hanger ball 78 and the catch face 112 of the clamp 79 bears against the hanger ball 78 to apply a compressive force to the hanger ball 78 that presses the hanger ball 78 against the ball seat 72. Thus, the hanger ball 78 is compressively retained or locked between the clamp 79 and the ball seat 72. Further, a frictional force between the catch face 112 and the hanger ball 78 resists or prevents motion of the hanger ball 78 relative to the ball seat 72. The catch face 112 having a serrated edge or serrated surface can increase the frictional force between the catch face 112 and the hanger ball 78 and improve resistance to motion of the hanger ball 78 when the clamp 79 is in the clamped position.

The clamp 79 can then be secured in the clamped position by passing a fastener 114 through the ball seat 72 and the latch 110 of the clamp 79. When the clamp 79 is pivoted about the hinged coupling 122 to the clamped position, the through hole 118 of the clamp 79 is aligned with the through hole 98 in the ball seat 72 such that together, the through holes 98, 118 can receive the fastener 114 and the clamp 79 can be fixed to ball seat 72 in the clamped position. As such, engagement between hanger ball 78 within the plate opening 106 can be secured and the pivotal or rotational movement of the hanger ball 78 relative to the ball seat 72 can be restricted or prevented.

The clamping force applied to the hanger ball 78 by the clamp 79 can be predetermined to exceed an anticipated maximum operating load acting on the hanger ball 78. For example, a maximum load will correspond to the maximum angle, relative to vertical, that the downrod 68 is capable, which will create the greatest gravitational load from the fan attached to the downrod 68. In addition, when the fan is located outdoors, a maximum aerodynamic force, attributable to wind blowing on the fan blades and providing a force component that is colinear with the gravitational load. The sum of these two force components can form a maximum expected load, which the clamping force can be designed to offset and prevent motion in response to the maximum load occurring during operation.

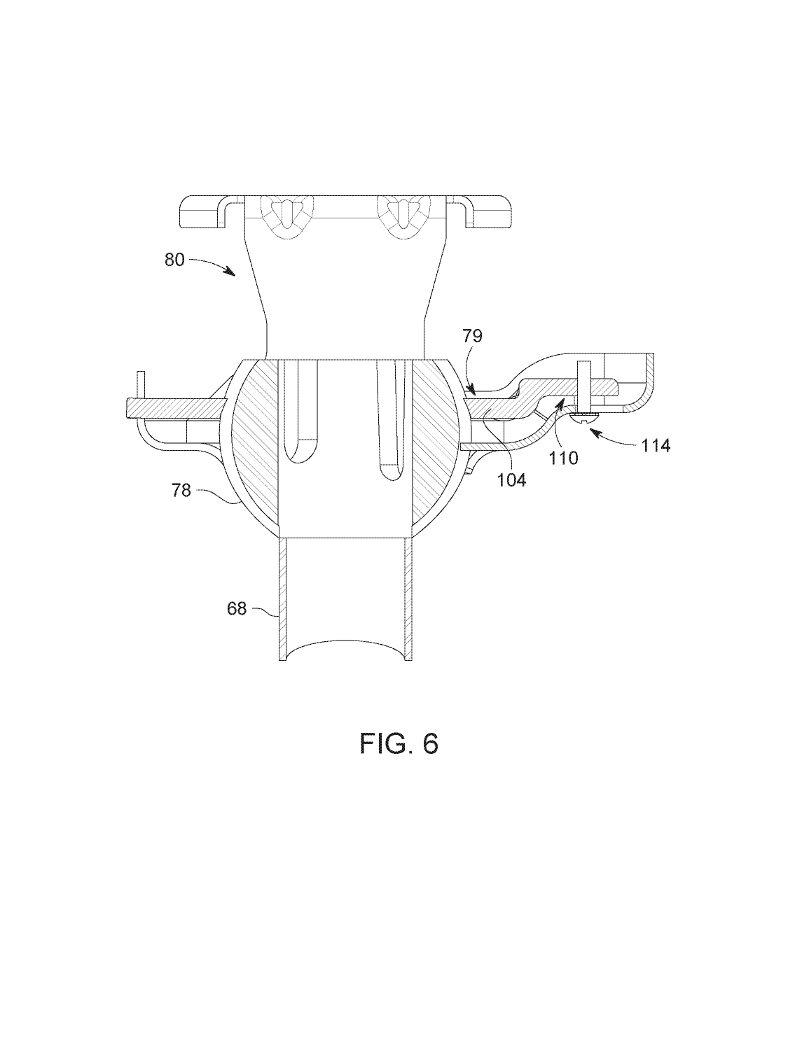

Referring to FIG. 6, as illustrated, the latching finger 120 can have a stepped profile relative to the portion of the clamp 79 that forms the plate opening 106, where the profile of the latching finger 120 corresponds to a portion of the ball seat 72. In such a configuration, when the clamp 79 is in the clamped position, the profile of the latching finger 120 can engage the portion of the ball seat 72 which readily aligns the through holes 98, 118 for the fastener 114 to pass therethrough and eases assembly between the clamp 79 and the ball seat 72.

Further, as illustrated, when the clamp 79 is in the clamped position, the hanger ball 78 extends through the plate opening 106 of the clamp 79 and an entirety of the clamp 79 lies below an uppermost portion of the hanger ball 78.

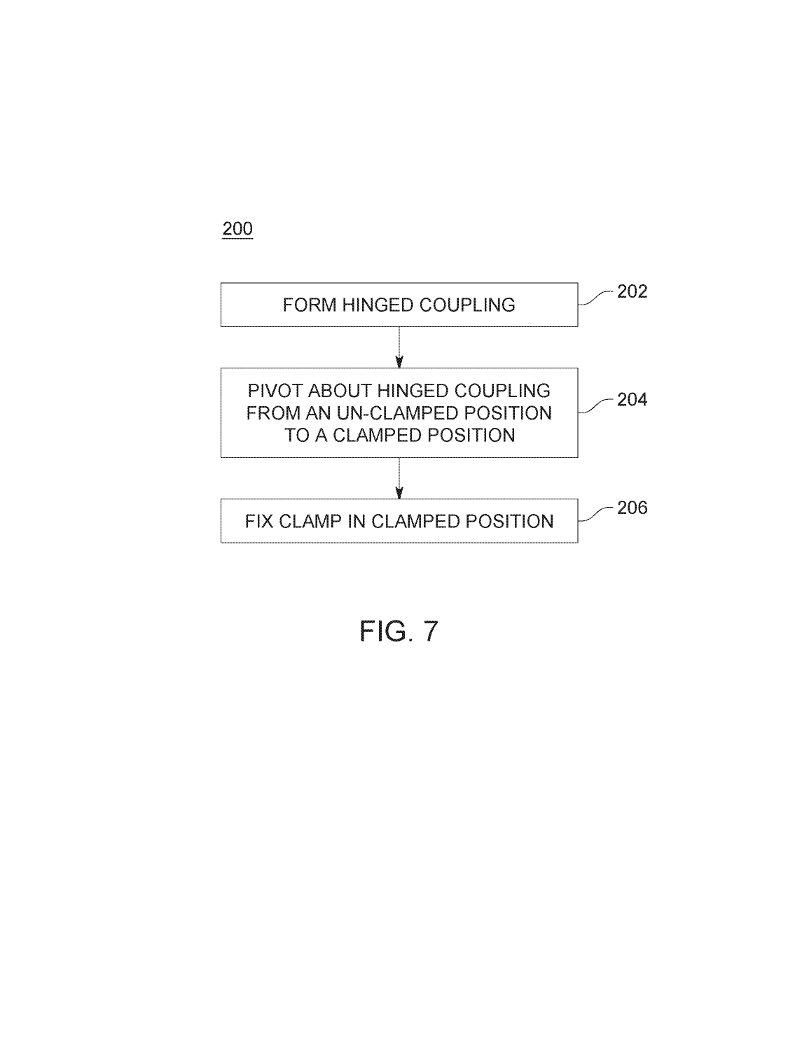

FIG. 7 is a method 200 of fixing a relative position of the hanger ball 78 in the hanger bracket 66 in a ceiling fan mounting assembly (e.g., in a ceiling fan assembly 10) of FIGS. 1-6.

At step 202, the downrod 68 is attached to the hanger ball 78 that is seated in the ball seat 72, and the downrod 68 is oriented into a desired angular position. The clamp 79 is positioned above the hanger ball 78, during or after the downrod 68 is in the desired angular orientation. The clamp 79 is moved into position relative to the hanger ball 78 by passing the clamp 79 over a top of the hanger ball 78. The clamp 79 is oriented, during or after being positioned above the hanger ball 78, where the tabs 116 of the clamp 79 are lowered into the slots 94 of the ball seat 72, which can be referred to as the un-clamped position. The tabs 116 are slidably engaged into the slots 94 and collectively form a hinged coupling 122 between the clamp 79 and the hanger bracket 66. When the hinged coupling 122 is formed, the plate opening 106 overlies the hanger ball 78 along the pivot path of the plate opening 106. In an alternative and non-limiting example, it is contemplated that the clamp 79 includes the slot and the ball seat 72 and the tab is received in the slot to form the hinged coupling 122.

At step 204, the clamp 79 is moved about the hinged coupling 122 from the un-clamped position to the clamped position. As the clamp 79 is moved to the clamped position, the plate opening 106 receives a portion of the hanger ball 78 and the catch face 112 of the clamp 79 bears against hanger ball 78 to apply a compressive force to the hanger ball 78 that presses or biases the hanger ball 78 against the ball seat 72.

At step 206, a fastener 114 is passed through the ball seat 72 and the clamp 79 and fixes the hanger ball 78 to the ball seat 72 in the clamped position. As such, engagement between hanger ball 78 within the plate opening can be secured and the pivotal or rotational movement of the hanger ball 78 relative to the ball seat 72 can be restricted or prevented.

Throughout the disclosure, suitable fasteners are described for securing different components. Such fasteners can be any type of fastener. In many cases the suitable fastener is a screw or a bolt. If the fastener is a bolt, then the opening that the bolt is threaded through will be a tapped opening having complementary threads for receipt of the bolt.

The ceiling fan assembly 10 can be sold in different commercially available kits. For example, a complete kit would include the hanger bracket assembly 60; a motor assembly 14; a blade set 16; optionally, a light assembly 18. However, the hanger bracket assembly 60 could be commercially sold as a stand-alone kit. Other commercially available kits can be formed from subassemblies. For example, the hanger bracket 66 and clamp 79 could be sold as a retrofit kit for an already installed fan not having a clamp. In short, any possible combination of the assemblies and/or the components of an assembly can be sold as a kit in combination with the hanger bracket assembly 60. It is contemplated that most kits would include specific written instructions for how to assemble the assemblies and/or components with the hanger bracket assembly 60. In all of the different commercially available kits, the different components of the mounting kit can be unassembled, pre-assembled, or a portion of them pre-assembled. The greater the degree of pre-assembly, the easier it will be on the consumer.

While not shown in any of the drawings, a controller can be electrically coupled to a structure S electrical supply to control operation of the ceiling fan assembly 10. Alternatively, the controller can be wirelessly or communicatively coupled to the ceiling fan assembly 10, configured to control operation of the ceiling fan assembly 10 remotely, without a dedicated connection. Non-limiting examples of controls for the ceiling fan assembly 10 can include fan speed, fan direction, or light operation. Furthermore, a separate wireless controller, alone or in addition to the wired controller, can be communicatively coupled to a controller or a wireless receiver in the ceiling fan assembly 10 to control operation. It is further contemplated in one alternative example that the ceiling fan assembly 10 be operated by the wireless controller alone and is not operably coupled with the wired controller. The unlocked, locked, latched, unlatched positions or conditions are used herein to describes relevant operational positions or conditions and are not meant to describe the only locations where a locking, unlocking, latching, or unlatching occurs.

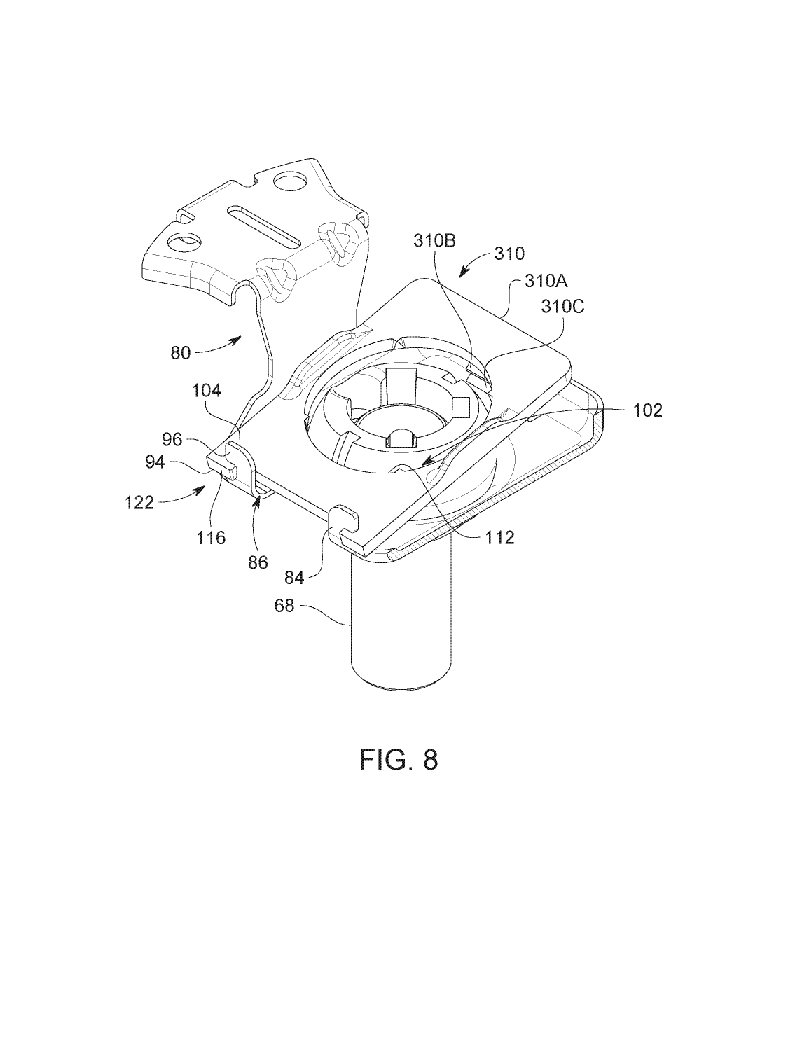

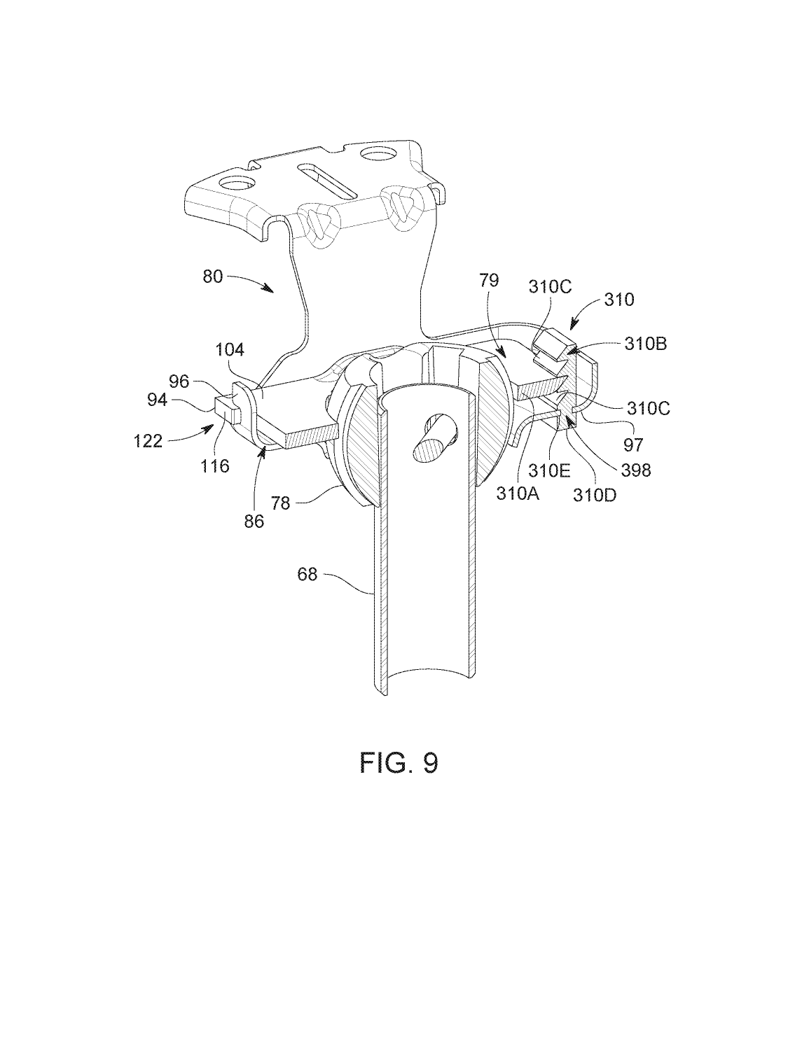

FIGS. 8 and 9 illustrate an alternative latch 310 for the latch 110 of FIGS. 1-7, which negates the need for a separate fastener. Therefore, only the latch 310 will be described in detail, with the understanding that the rest of the hanger bracket assembly 60 is the structurally and operationally the same, unless expressly noted. The similar, yet different, parts for the latch 310 will be in the 300 series. However, all other parts will use the same numerals as FIGS. 1-7.

The latch 310 is a detent latch having a strike 310A and a catch 310B. The strike 310A is received within the catch 310B to latch the clamp 79 in the clamped position. The strike 310A can be formed by the edge of the clamp 79, such as a natural edge of the clamp 79 or a specific or dedicated edge or a protrusion from the clamp 79 or a recess in the clamp 79.

The catch 310B comprises a multiple detents 310C, each of which can receive the strike 310A, which provides for multiple latching positions and a corresponding multiple levels of clamping force. The catch 310B can be made of a resilient material to permit the deflection of the catch 310B to release the strike 310A. Alternatively, the catch 310 can be made and/or secured to the structure mount 80 to permit movement for unlatching.

As illustrated, the catch 310B is made of a flexible body having a base 310D defining a channel 310E, above which are the series of detents 310C. The base 310D is mounted to the support ledge 97 by passing the base 310D through a through hole 398 such that the portion of the support ledge 97 defining the through hole 398 is received within the channel 310E, which secures the catch 310B to the support ledge 97.

The channel 310 E forms a reduced thickness to the catch 310B and functions as a pivot or deflection point for the catch 310B. The catch 310 can be made of a deflectable or resilient material that provides the desired amount of deflection. The catch 310B can be made of multiple materials. For example, the base 310D can be made of a material that can be deflected into the through hole 98, while the portion with the multiple detents can be made of less flexible or less deformable material to hold the strike 310. Thus, the hardness can be greater for the portion with the detents 310C as compared to the base 310D. The portion with the detents 310C could even be made of metal while the base 310D is made of plastic or elastomer, which is attached to the metal, such as by moulding.

With the latch 310, the securing of the clamp 79 is simpler because it does not require a separate fastener. The user merely rotates the clamp 79, as previously described, toward the multiple detents 310C. As the strike 310A makes contact with the multiple detents 310C, which are initially deflected out of the way. Upon the cessation of rotation, the multiple detents are resiliently returned and one of the detents 310C will receive the strike 310A and hold it in place. To unlatch or adjust the clamp 79, the user merely deflects the multiple detents 310C, until the strike 310A is free to move and be repositioned or unlatched.

While two examples of a latch 110 and 310 are illustrated, these examples are not limiting and other suitable latches can be used.

To the extent not already described, the different features and structures of the various features can be used in combination as desired. That one feature is not illustrated in all of the aspects of the disclosure is not meant to be construed that it cannot be but is done for brevity of description. Thus, the various features of the different aspects described herein can be mixed and matched as desired to form new features or aspects thereof, whether or not the new aspects or features are expressly described. All combinations or permutations of features described herein are covered by this disclosure.

This written description uses examples to detail the aspects described herein, including the best mode, and to enable any person skilled in the art to practice the aspects described herein, including making and using any devices or systems and performing any incorporated methods. The patentable scope of the aspects described herein are defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

Further aspects are provided by the subject matter of the following clauses:

A hanger bracket assembly for mounting a ceiling fan to a structure, the hanger bracket assembly comprising: a hanger bracket having a structure mount and a ball seat defined by a portion of the structure mount; a downrod terminating in a hanger ball, which is seated in the ball seat for pivotal or rotational movement; and a clamp pivotally coupled to the hanger bracket and pivotal between an un-clamped position and a clamped position, where in the clamped position, the clamp applies a force to the hanger ball to lock the hanger ball in place and restricts the pivotal or rotational movement.

The hanger bracket assembly of any preceding clause, wherein a tab on one of the clamp or the hanger bracket together with a slot, which receives the tab, on the other of the clamp or the hanger bracket pivotally couples the clamp to the hanger bracket.

The hanger bracket assembly any preceding clause, wherein the slot is located on the hanger bracket and the tab is located on the clamp.

The hanger bracket assembly any preceding clause, wherein the hanger bracket has an arm defining a portion of the slot.

The hanger bracket assembly any preceding clause, wherein the clamp has an opening that receives the hanger ball when the clamp is in the clamped position.

The hanger bracket assembly any preceding clause, wherein the clamp further comprises a latch that is coupled to the hanger bracket when the clamp is in the clamped position.

The hanger bracket assembly any preceding clause, wherein the latch is a latching finger overlying a portion of the hanger bracket and further comprising a fastener passing through the latching finger and into the hanger bracket.

The hanger bracket assembly any preceding clause, wherein an entirety of the clamp lies below an uppermost portion of the hanger ball in the clamped position.

The hanger bracket assembly any preceding clause, wherein the clamp comprises a body having an opening through which a portion of the hanger ball passes when the clamp is in the clamped position.

The hanger bracket assembly any preceding clause, wherein the clamp lies below an uppermost portion of the hanger ball in the clamped position.

The hanger bracket assembly any preceding clause further comprising a hinged coupling between the clamp and the hanger bracket, with the clamp pivoting about the hinged coupling.

The hanger bracket assembly any preceding clause, wherein the hinged coupling comprises a portion on the clamp and a portion on the hanger bracket, with the portion on the clamp and the portion on the hanger bracket in an overlapping relationship.

The hanger bracket assembly any preceding clause, wherein the portion on the clamp is a tab and the portion on the hanger bracket is a slot.

A ceiling fan assembly for mounting to a structure, the ceiling fan assembly comprising: a hanger bracket having a structure mount and a ball seat; a ceiling fan having a rotor; a plurality of blades operably coupled to the rotor; a downrod having a first end and a second end, with the second end coupled to the ceiling fan; a hanger ball couples to the first end of the downrod and is received within the ball seat; a clamp applying a compressive force to the hanger ball to press the hanger ball against the ball seat; and a hinged coupling between the clamp and the hanger bracket, wherein the clamp is pivoted about the hinged coupling between a clamped position, where the clamp applies the compressive force to the hanger ball at an un-clamped position.

The ceiling fan assembly any preceding clause, wherein the clamp comprises an opening through which a portion of the hanger ball passes as the clamp is pivoted between the un-clamped position and the clamped position.

The ceiling fan assembly any preceding clause, wherein the hinged coupling comprises a portion on the hanger bracket and a portion on the clamp, where the portion on the hanger bracket and the portion on the clamp cooperate and form the hinged coupling.

The ceiling fan assembly any preceding clause, wherein the portion on the hanger bracket is one of a tab or a slot and the portion on the clamp is the other of the tab or slot.

The ceiling fan assembly any preceding clause, wherein the clamp is a plate from which the tab extends and the hanger bracket has the slot, the plate overlies the hanger ball, and the tab is received in the slot to form the hinge.

The ceiling fan assembly any preceding clause, wherein the slot is located in the ball seat.

The ceiling fan assembly any preceding clause, wherein the plate further comprises a latching finger that is secured to the hanger bracket to fix the clamp in the clamped position.

The ceiling fan assembly any preceding clause, wherein the plate comprises an opening through which at least a portion of the hanger ball extends through when the clamp is in the clamped position.

The ceiling fan assembly any preceding clause, wherein an entirety of the clamp lies below an uppermost portion of the hanger ball when the clamp is in the clamped position.

A method of fixing a relative position of a hanger ball in a hanger bracket in a ceiling fan mounting assembly, the method comprising: forming a hinged coupling between a clamp and the hanger bracket; pivoting the clamp about the hinged coupling in a clamped position where the clamp applies a compressive force to the hanger ball to bias the hanger ball against the hanger bracket; and fixing the clamp in the clamped position.

The method of any preceding clause, wherein the forming the hinged coupling comprises sliding a tab on the clamp into a slot on the hanger bracket.

The method any preceding clause, wherein the sliding the tab comprises moving the clamp over a top of the hanger ball until an opening in the clamp overlies the hanger ball.

The method any preceding clause, wherein pivoting the clamp comprises receiving a portion of the hanger ball in the opening as the clamp is pivoted to the clamped position.

The method any preceding clause, wherein the fixing the clamp in the clamped position comprises fastening the clamp to the hanger bracket.

The method any preceding clause, wherein an entirety of the clamp lies below an uppermost portion of the hanger ball when the clamp is in the clamped position.

What is claimed is:

1. A hanger bracket assembly for mounting a ceiling fan to a structure, the hanger bracket assembly comprising:
a hanger bracket having a structure mount and a ball seat defined by a portion of the structure mount;
a downrod terminating in a hanger ball, which is seated in the ball seat for pivotal or rotational movement; and
a clamp pivotally coupled to the hanger bracket and pivotal between an un-clamped position and a clamped position, where in the clamped position, the clamp applies a force to the hanger ball to lock the hanger ball in place and restricts the pivotal or rotational movement.

2. The hanger bracket assembly of claim 1, wherein a tab on one of the clamp or the hanger bracket together with a slot, which receives the tab, on the other of the clamp or the hanger bracket pivotally couples the clamp to the hanger bracket.

3. The hanger bracket assembly of claim 2, wherein the slot is located on the hanger bracket and the tab is located on the clamp.

4. The hanger bracket assembly of claim 3, wherein the hanger bracket has an arm defining a portion of the slot.

5. The hanger bracket assembly of claim 4, wherein the clamp has an opening that receives the hanger ball when the clamp is in the clamped position.

6. The hanger bracket assembly of claim 5, wherein the clamp further comprises a latch that is coupled to the hanger bracket when the clamp is in the clamped position.

7. The hanger bracket assembly of claim 6, wherein the latch is a latching finger overlying a portion of the hanger bracket and further comprising a fastener passing through the latching finger and into the hanger bracket.

8. The hanger bracket assembly of claim 7, wherein an entirety of the clamp lies below an uppermost portion of the hanger ball in the clamped position.

9. The hanger bracket assembly of claim 1, wherein the clamp comprises a body having an opening through which a portion of the hanger ball passes when the clamp is in the clamped position.

10. The hanger bracket assembly of claim 9, wherein the clamp lies below an uppermost portion of the hanger ball in the clamped position.

11. The hanger bracket assembly of claim 1 further comprising a hinged coupling between the clamp and the hanger bracket, with the clamp pivoting about the hinged coupling.

12. The hanger bracket assembly of claim 11, wherein the hinged coupling comprises a portion on the clamp and a portion on the hanger bracket, with the portion on the clamp and the portion on the hanger bracket in an overlapping relationship.

13. The hanger bracket assembly of claim 12, wherein the portion on the clamp is a tab and the portion on the hanger bracket is a slot.

14. A ceiling fan assembly for mounting to a structure, the ceiling fan assembly comprising:
a hanger bracket having a structure mount and a ball seat;
a ceiling fan having a rotor;
a plurality of blades operably coupled to the rotor;
a downrod having a first end and a second end, with the second end coupled to the ceiling fan;
a hanger ball couples to the first end of the downrod and is received within the ball seat;
a clamp applying a compressive force to the hanger ball to press the hanger ball against the ball seat; and
a hinged coupling between the clamp and the hanger bracket, wherein the clamp is pivoted about the hinged coupling between a clamped position, where the clamp applies the compressive force to the hanger ball at an un-clamped position.

15. The ceiling fan assembly of claim 14, wherein the clamp comprises an opening through which a portion of the hanger ball passes as the clamp is pivoted between the un-clamped position and the clamped position.

16. The ceiling fan assembly of claim 14, wherein the hinged coupling comprises a portion on the hanger bracket and a portion on the clamp, where the portion on the hanger bracket and the portion on the clamp cooperate and form the hinged coupling.

17. The ceiling fan assembly of claim 16, wherein the portion on the hanger bracket is one of a tab or a slot and the portion on the clamp is the other of the tab or slot.

18. The ceiling fan assembly of claim 17, wherein the clamp is a plate from which the tab extends and the hanger bracket has the slot, the plate overlies the hanger ball, and the tab is received in the slot to form the hinge.

19. The ceiling fan assembly of claim 18, wherein the slot is located in the ball seat.

20. The ceiling fan assembly of claim 19, wherein the plate further comprises a latching finger that is secured to the hanger bracket to fix the clamp in the clamped position.
